(19) United States
(12) Patent Application Publication
(10) Pub. No.: US 2020/0165886 A1
(43) Pub. Date: May 28, 2020

(54) SYSTEM AND METHOD FOR RECOVERING LOST DRILLING MUD OVER SHALE SLIDES

(71) Applicant: 1910293 ALBERTA LTD., Nisku (CA)

(72) Inventors: Calvin S. E. BABLITZ, Leduc (CA); Frank J. K. EDWARDS, High River (CA)

(21) Appl. No.: 16/632,254

(22) PCT Filed: Jul. 17, 2018
(86) PCT No.: PCT/IB2018/000927

§ 371 Date: Jan. 17, 2020

Related U.S. Application Data
(60) Provisional application No. 62/533,792, filed on Jul. 18, 2017.

(51) Int. Cl. E21B 21/06; B01D 29/03; B01D 29/92; B01D 35/027; B01D 21/28; B01D 36/04

(52) U.S. Cl. CPC E21B 21/065; B01D 29/03; B01D 36/04; B01D 35/027; B01D 21/283; B01D 29/92

(57) ABSTRACT

An apparatus and method for recovering drilling fluid from drill cuttings, drill mud detritus solids, or both, lost over shale slides utilizing a vacuum suction system. Alternatively, the system may be used to recover drilling fluid directly from drill cuttings and drill mud detritus solids with the benefit of mud shaker systems. The embodied apparatus mounts to the end of a shale slide. The apparatus has a mesh screen, auto-adjust vacuum system, and an auto-adjustable pump return system with fluid monitoring system to return recovered waste drilling fluid to the mud tank.

### CROSS-REFERENCE

This application claims the benefit of U.S. Provisional Application No. 62/533,792, filed Jul. 18, 2017, which application is incorporated herein by reference.

### BACKGROUND OF THE INVENTION

Various systems and methods have been developed for capturing drilling fluid from lost over mud shaker systems. The loss of drilling fluids presents several expensive challenges to the energy exploration industry as a result of the loss of drilling fluids to the formation and/or from the disposal of drilling detritus or cuttings that are contaminated with drilling fluid. During the excavation or drilling process, drilling fluid losses can reach levels approaching 300 cubic meters of lost drilling fluid over the course of a drilling program. With some drilling fluids having values in excess of $1000 per cubic meter, the loss of such volumes of fluids represents a substantial cost to drill operators. Unfortunately, the techniques used to date have been less than cost effective for many drilling fluids as the cost of capital investment and operational costs outweigh the benefit of recovered drilling fluid; or simply are ineffective in the reclamation of adequate quantities of reusable fluid. As a result, there is a continued need to develop a low-cost retrofit technology which can enhance fluid recovery and do so at a fractional cost relative to mechanisms and technologies currently employed to minimize drilling fluid losses both downhole and at surface.

### SUMMARY OF THE INVENTION

Described herein is an apparatus and method for recovering drilling fluid from drill cuttings and drill mud detritus solids lost over shale slides utilizing a vacuum suction system. Alternatively, the system may be used in combination with mud shaker systems to recover drilling fluid from drill cuttings and drill mud detritus solids. The embodied apparatus mounts to the end of a shale slide. The apparatus has a mesh screen, auto adjust vacuum system, and an auto adjustable pump return system with fluid monitoring system to return recovered waste drilling fluid to the mud tank.

Provided herein is an apparatus for recovery of drilling fluid from drill cuttings on a shale slide, the apparatus comprising: a flow barrier catch tray configured for mounting to the shale slide; a fluid filter screen mounted in the flow barrier catch tray configured to be in direct contact with detritus material flow in the shale slide, the detritus material flow comprising drilling fluid and drill cuttings; a system suction line having first and second ends, the first end adapted to provide suction to the fluid filter screen suction line and to draw the drilling fluid from the detritus material flow through the fluid filter screen; a vacuum suction system to provide the suction to the fluid filter screen, the system comprising an air suction pump for applying suction to the second end of the system suction line and drawing the drilling fluid into a fluid capture recovery storage tank, and a fluid return pump actuatable by a fluid level float and a tank level switch, for pumping recovered drilling fluid exceeding a fluid level detectable by the fluid float and the tank level switch from the recovery storage tank. In any embodiment, the apparatus further comprises a power supply control system for providing power to the apparatus, automated control of the apparatus, or both. In any embodiment, the apparatus further comprises a self-contained cabinet comprising the power supply control system, the fluid capture recovery storage tank; the vacuum suction system comprising the air suction pump, the fluid return pump, and the fluid level float and the tank level switch. In any embodiment, the apparatus further comprises a fluid meter for measuring a volume of recovered drilling fluid. In any embodiment, the apparatus further comprises a discharge return port coupled to a discharge return line for removal of recovered drilling fluid from the storage tank. In any embodiment of the apparatus, the storage tank is adapted for temporarily storing the recovered drilling fluid before reuse. In any embodiment of the apparatus, the self-contained cabinet further comprises a vacuum relief valve to control air flow in the vacuum suction system. In any embodiment of the apparatus, the fluid capture recovery storage tank further comprises a floating suction tube for skimming fluid from the recovered drilling fluid. In any embodiment of the apparatus, the fluid capture recovery storage tank further comprises a system for utilizing air returning from the fluid filter screen to generate an air agitation mechanism for agitating the recovered drilling fluid and for preventing low gravity solids suspended in the recovered drilling fluid from settling to the bottom of the tank. In any embodiment of the apparatus, the fluid level float is configured to function in concert with the tank level switch to activate a timer in a starter box for controlling the fluid return pump. In any embodiment of the apparatus, the fluid return pump is configured for providing positive pressure fluid flow to pump recovered drilling fluid from the fluid capture recovery storage tank. In any embodiment of the apparatus, the fluid meter is configured such that recovered drilling fluid from the fluid capture recovery storage tank is pumped therethrough, such that the fluid meter records a flow volume of recovered drilling fluid. In any embodiment of the apparatus, the discharge return port and the discharge line are configured such that recovered drilling fluid may be pumped therethrough to a mud tank. In any embodiment, the apparatus further comprises an agitator for agitating the shale slide, thus facilitating detritus material flow. In any embodiment of the apparatus, the agitator comprises a vibratory system and an impactor system. In any embodiment, the apparatus further comprises an adjustor for adjusting the angle of the shale slide. In any embodiment of the apparatus, the adjustor comprises one or more of: a manual system; a hydraulic system and an electric system. In any embodiment of the apparatus, the flow barrier catch tray is configured with a mounting attachment that provides for temporary relocation or removal of the flow barrier catch tray away from the direct path of the drill cuttings, drill mud detritus solids, or both on the shale slide. In any embodiment of the apparatus, the mounting attachment for the flow barrier catch tray is configured to allow for the temporary placement or storage of the flow barrier catch tray beneath the shale slide. In any embodiment of the apparatus, the fluid filter screen is removable. In any embodiment of the apparatus, the vacuum relief valve is auto-adjusting. In any embodiment of the apparatus, the power supply control system further comprises a computer implemented system for automated control of the apparatus comprising: a digital processing device comprising an operating system configured to perform executable instructions and a memory; a computer program including instructions executable by the digital processing device to create an application comprising: a software module configured to manage a (liquid) fluid pumping operation of the apparatus; a software module configured to manage an (air/gas) fluid pumping operation of the apparatus; a software module configured to monitor a plurality of sensors; a software module configured to manage a plurality of switches; a software module configured to monitor and track overall run-time of the apparatus; and a software module configured to manage an electrical system of the apparatus. In any embodiment, a plurality of sensors is configured to monitor apparatus parameters comprising one or more of: liquid fluid flow, air fluid flow, vacuum pressure, fluid levels, and power levels.

Provided herein is a method for recovery of drilling fluid from drill cuttings comprising: mounting a flow barrier catch tray to a shale slide; affixing a fluid filter screen in the flow barrier catch tray configured to be in direct contact with a detritus material flow in the shale slide, the detritus material flow comprising drilling fluid and drill cuttings; attaching a system suction line having first and second ends, the first end adapted to provide suction to the fluid filter screen and to draw the drilling fluid from the detritus material flow through the fluid filter screen; providing a vacuum suction system to provide the suction to the fluid filter screen, the system comprising an air suction pump for applying suction to the second end of the system suction line and drawing the drilling fluid into a fluid capture recovery storage tank, and providing a fluid return pump actuatable by a fluid level float and a tank level switch, for pumping recovered drilling fluid exceeding a fluid level detectable by the fluid float and the tank level switch from the recovery storage tank.

Provided herein is an apparatus for recovery of drilling fluid from drill cuttings, drill mud detritus solids, or both on a shale slide, the apparatus comprising a catch tray configured for mounting to the shale slide; a fluid filter screen mounted in the catch tray configured to be in direct contact with detritus material flow in the shale slide, the detritus material flow comprising drilling fluid and drill cuttings; a suction line having first and second ends, the first end adapted to provide suction to the fluid filter screen and to draw the drilling fluid from the detritus material flow through the fluid filter screen; a vacuum suction system to provide the suction to the fluid filter screen, the system comprising an air suction pump for applying suction to the second end of the suction line and drawing the drilling fluid into a fluid capture recovery storage tank, and a fluid return pump actuatable by a fluid level float and a tank level switch, for pumping recovered drilling fluid exceeding a fluid level detectable by the fluid float and the tank level switch from the recovery storage tank. In any embodiment, the apparatus further comprises a power supply control system for providing power to the apparatus, or automated control of the apparatus, or both. In any embodiment, the apparatus further comprising a self-contained cabinet comprises the power supply control system, the fluid capture recovery storage tank; the vacuum suction system comprising the air suction pump, the fluid return pump, and the fluid level float and the tank level switch. In any embodiment, the apparatus further comprises a fluid meter for measuring a volume of recovered drilling fluid. In any embodiment, the apparatus further comprises a discharge return port coupled to a discharge return line for removal of recovered drilling fluid from the storage tank. In any embodiment of the apparatus, the storage tank is adapted for temporarily storing the recovered drilling fluid before reuse. In any embodiment of the apparatus, the self-contained cabinet further comprises a vacuum relief valve to control air flow in the vacuum suction system. In any embodiment of the apparatus, the fluid capture recovery storage tank further comprises a floating suction tube for skimming fluid from the recovered drilling fluid. In any embodiment of the apparatus, the fluid capture recovery storage tank further comprises a system for utilizing air returning from the fluid filter screen to generate an air agitation mechanism for agitating the recovered drilling fluid and for preventing low gravity solids suspended in the recovered drilling fluid from settling to the bottom of the tank. In any embodiment of the apparatus, the fluid level float is configured to function in concert with the tank level switch to activate a timer in a starter box for controlling the fluid return pump. In any embodiment of the apparatus, the fluid return pump is configured for providing positive pressure fluid flow to pump recovered drilling fluid from the fluid capture recovery storage tank. In any embodiment of the apparatus, the fluid meter is configured such that recovered drilling fluid from the fluid capture recovery storage tank is pumped therethrough, such that the fluid meter records a flow volume of recovered drilling fluid. In any embodiment of the apparatus, the discharge return port and the discharge line are configured such that recovered drilling fluid may be pumped therethrough to a mud tank. In any embodiment, the apparatus further comprises an agitator for agitating the shale slide, thus facilitating detritus material flow. In any embodiment of the apparatus, the agitator comprises; a vibratory system; and an impactor system. In any embodiment, the apparatus further comprises an adjustor for adjusting the angle of the shale slide. In any embodiment of the apparatus, the adjustor comprises one or more of: a manual system; a mechanical spring system; a hydraulic system; and an electric system. In any embodiment of the apparatus, the catch tray further comprises a flow barrier to create a flow barrier catch tray. In any embodiment of the apparatus, the fluid filter screen is removable from the catch tray. In any embodiment of the apparatus, the vacuum relief valve is auto-adjusting. In any embodiment of the apparatus, the power supply control system further comprises a computer implemented system for automated control of the apparatus comprising: a digital processing device comprising an operating system configured to perform executable instructions and a memory; a computer program including instructions executable by the digital processing device to create an application comprising: a software module configured to manage a (liquid) fluid pumping operation of the apparatus; a software module configured to manage an (air/gas) fluid pumping operation of the apparatus; a software module configured to monitor a plurality of sensors; a software module configured to manage a plurality of switches; a software module configured to monitor and track monitor and track overall run-time of the apparatus; and a software module configured to manage an electrical system of the apparatus. In any embodiment of the apparatus, the plurality of sensors are configured to monitor apparatus parameters comprising one or more of: liquid fluid flow, air fluid flow, vacuum pressure, fluid levels, and power levels.

Provided herein is a method for recovery of drilling fluid from drill cuttings comprising; mounting a catch tray to a shale slide; affixing a fluid filter screen in the catch tray configured to be in direct contact with a detritus material flow in the shale slide, the detritus material flow comprising drilling fluid and drill cuttings; attaching a system suction line having first and second ends, the first end adapted to provide suction to the to a filter suction line attached fluid filter screen and to draw the drilling fluid from the detritus material flow through the fluid filter screen; providing a vacuum suction system to provide the suction to the fluid filter screen, the system comprising an air suction pump for applying suction to the second end of the system suction line and drawing the drilling fluid into a fluid capture recovery storage tank, and providing a fluid return pump actuatable by a fluid level float, the fluid level float configured to function in concert with the tank level switch to activate a timer in a starter box for controlling the fluid return pump and a tank level switch, for pumping recovered drilling fluid exceeding a fluid level detectable by the fluid float and the tank level switch from the recovery storage tank.

Provided herein is an apparatus for recovery of drilling fluid from drill cuttings on a shale slide, the apparatus comprising; a catch tray configured for mounting to the shale slide; a removable fluid filter screen mounted in the catch tray configured to be in direct contact with detritus material flow in the shale slide, the detritus material flow comprising drilling fluid and drill cuttings; a suction line having first and second ends, the first end adapted to provide suction to the fluid filter screen and to draw the drilling fluid from the detritus material flow through the fluid filter screen; a vacuum suction system to provide the suction to the fluid filter screen, the system comprising an air suction pump for applying suction to the second end of the suction line and drawing the drilling fluid into a fluid capture recovery storage tank, the storage tank being adapted for temporarily storing the recovered drilling fluid before reuse, the tank comprising a floating suction tube for skimming fluid from the recovered drilling fluid and a system for utilizing air returning from the fluid filter screen to generate an air agitation mechanism for agitating the recovered drilling fluid and for preventing low gravity solids suspended in the recovered drilling fluid from settling to the bottom of the tank; a fluid return pump actuatable by a fluid level float and a tank level switch, for pumping recovered drilling fluid exceeding a fluid level detectable by the fluid float and the tank level switch from the recovery storage tank, the pump configured for providing positive pressure fluid flow to pump recovered drilling fluid from the fluid capture recovery storage tank; a power supply control system for providing power to the apparatus, or automated control of the apparatus, or both; a self-contained cabinet comprising: the power supply control system; the fluid capture recovery storage tank; the vacuum suction system comprising the air suction pump, the fluid return pump; the fluid level float and the tank level switch; and an auto-adjusting vacuum relief valve to control air flow in the vacuum suction system; a fluid meter for measuring a volume of recovered drilling fluid, the fluid meter configured such that recovered drilling fluid from the fluid capture recovery storage tank is pumped therethrough, such that the fluid meter records a flow volume of recovered drilling fluid; a discharge return port coupled to a discharge return line for removal of recovered drilling fluid from the storage tank, the discharge return port and the discharge line configured such that recovered drilling fluid may be pumped therethrough to a mud tank; an agitator for agitating the shale slide, thus facilitating detritus material flow, the agitator comprising a vibratory system and an impactor system; and an adjustor for adjusting the angle of the shale slide, the adjustor comprising one or more of: a manual system; a hydraulic system; and an electric system. In any embodiment of the apparatus, the catch tray is configured with a mounting attachment that provides for temporary relocation or removal of the flow barrier catch tray away from the direct path of the drill cuttings, -drill mud detritus solids, or both on the shale slide. In any embodiment of the apparatus, the mounting attachment for the flow barrier catch tray is configured to allow for the temporary placement or storage of the flow barrier catch tray beneath the shale slide.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a front view of the catch tray illustrating the to the filter screen attached and filter screen vacuum suction lines;

FIG. 2 is a detail illustrative view of the detritus (shale) catch trays mounted near the ends of typical shale slides;

FIG. 3 is another illustrative view of the catch trays mounted near the ends of typical shale slides in a typical shale bin;

FIG. 4 is a front view of the power cabinet of the drilling fluid recovery apparatus;

FIG. 5 is a front view of the inside of the power cabinet of the drilling fluid recovery apparatus illustrating the compact nature of the components of the system;

FIG. 6A is an illustrative view of the left side of the power cabinet of the drilling fluid recovery apparatus;

FIG. 6B is an illustrative view of the right side of the power cabinet of the drilling fluid recovery apparatus;

FIG. 7 is an illustrative perspective view of the back and left sides of the power cabinet of the drilling fluid recovery apparatus, showing the location of the drilling fluid recovery and storage tank in the back of the cabinet, as well as the suction and discharge ports on the side;

FIG. 8 is an illustrative front perspective view of the entire assembled drilling fluid recovery apparatus;

FIG. 9 is a top view of the recovery tank (empty);

FIG. 10 is an illustrative top perspective view of the recovery tank (full) showing the incoming system suction line (from the filter screen), the fluid return line (to the mud tank) and an illustrative floating fluid skimming suction (output) discharge line;

FIG. 11 is an illustrative flow chart of a computer implemented system for automated control of the apparatus;

FIG. 12 is an illustrative table showing a cost analysis and savings of recovered drilling fluid obtained using the described processing apparatus and method;

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE INVENTION

Described herein, in any embodiment is a system for recovering drilling fluid from drill cuttings and drill mud detritus solids lost over shale slides utilizing a vacuum suction system.

Also described herein, in any embodiment, the system may be used in combination with mud shaker systems to recover drilling fluid from drill cuttings and drill mud detritus solids.

Also described herein, in any embodiment, is a method for recovery of drilling fluid from drill cuttings comprising: mounting a flow barrier catch tray to a shale slide; affixing a fluid filter screen in the flow barrier catch tray configured to be in direct contact with a detritus material flow in the shale slide, the detritus material flow comprising drilling fluid and drill cuttings; attaching a system suction line having first and second ends, the first end adapted to provide suction to the fluid filter screen and to draw the drilling fluid from the detritus material flow through the fluid filter screen; providing a vacuum suction system to provide the suction to the fluid filter screen, the system comprising an air suction pump for applying suction to the second end of the system suction line and drawing the drilling fluid into a fluid capture recovery storage tank, and providing a fluid return pump actuatable by a fluid level float and a tank level switch, for pumping recovered drilling fluid exceeding a fluid level detectable by the fluid float and the tank level switch from the recovery storage tank.

Also described herein, in any embodiment, is an apparatus for recovery of drilling fluid from drill cuttings, drill mud detritus solids, or both on a shale slide, the apparatus comprising a catch tray configured for mounting to the shale slide; a fluid filter screen mounted in the catch tray configured to be in direct contact with detritus material flow in the shale slide, the detritus material flow comprising drilling fluid and drill cuttings; a suction line having first and second ends, the first end adapted to provide suction to the fluid filter screen and to draw the drilling fluid from the detritus material flow through the fluid filter screen; a vacuum suction system to provide the suction to the fluid filter screen, the system comprising an air suction pump for applying suction to the second end of the suction line and drawing the drilling fluid into a fluid capture recovery storage tank, and a fluid return pump actuatable by a fluid level float and a tank level switch, for pumping recovered drilling fluid exceeding a fluid level detectable by the fluid float and the tank level switch from the recovery storage tank.

Also described herein, in any embodiment, is a method for recovery of drilling fluid from drill cuttings comprising; mounting a catch tray to a shale slide; affixing a fluid filter screen in the catch tray configured to be in direct contact with a detritus material flow in the shale slide, the detritus material flow comprising drilling fluid and drill cuttings; attaching a system suction line having first and second ends, the first end adapted to provide suction to the to a filter suction line attached fluid filter screen and to draw the drilling fluid from the detritus material flow through the fluid filter screen; providing a vacuum suction system to provide the suction to the fluid filter screen, the system comprising an air suction pump for applying suction to the second end of the system suction line and drawing the drilling fluid into a fluid capture recovery storage tank, and providing a fluid return pump actuatable by a fluid level float, the fluid level float configured to function in concert with the tank level switch to activate a timer in a starter box for controlling the fluid return pump and a tank level switch, for pumping recovered drilling fluid exceeding a fluid level detectable by the fluid float and the tank level switch from the recovery storage tank.

Also described herein, in any embodiment, is an apparatus for recovery of drilling fluid from drill cuttings, drill mud detritus solids, or both on a shale slide, the apparatus comprising a catch tray configured for mounting to the shale slide; a fluid filter screen mounted in the catch tray configured to be in direct contact with detritus material flow in the shale slide, the detritus material flow comprising drilling fluid and drill cuttings; a suction line having first and second ends, the first end adapted to provide suction to the fluid filter screen and to draw the drilling fluid from the detritus material flow through the fluid filter screen; a vacuum suction system to provide the suction to the fluid filter screen, the system comprising an air suction pump for applying suction to the second end of the system suction line and drawing the drilling fluid into a fluid capture recovery storage tank, and providing a fluid return pump actuatable by a fluid level float, the fluid level float configured to function in concert with the tank level switch to activate a timer in a starter box for controlling the fluid return pump and a tank level switch, for pumping recovered drilling fluid exceeding a fluid level detectable by the fluid float and the tank level switch from the recovery storage tank; the system further comprising a power supply control system; the power supply control system further comprises a computer implemented system for automated control of the apparatus comprising: a digital processing device comprising an operating system configured to perform executable instructions and a memory; a computer program including instructions executable by the digital processing device to create an application comprising: a software module configured to manage a (liquid) fluid pumping operation of the apparatus; a software module configured to manage an (air/gas) fluid pumping operation of the apparatus; a software module configured to monitor a plurality of sensors; a software module configured to manage a plurality of switches; a software module configured to monitor and track overall run-time of the apparatus; and a software module configured to manage an electrical system of the apparatus. In any embodiment, a plurality of sensors is configured to monitor apparatus parameters comprising one or more of: liquid fluid flow, air fluid flow, vacuum pressure, fluid levels, and power levels.

### Certain Definitions

As used herein, and unless otherwise specified, the term “about” or “approximately” means an acceptable error for a particular value as determined by one of ordinary skill in the art, which depends in part on how the value is measured or determined. In any embodiment, the term “about” or “approximately” means within 1, 2, 3, or 4 standard deviations. In any embodiment, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In any embodiment, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In any embodiment, the term “about” or “approximately” means within 5.0 kg, 2.5 kg, 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In any embodiment, the term “about” or “approximately” means within 1 hour, within 45 minutes, within 30 minutes, within 25 minutes, within 20 minutes, within 15 minutes, within 10 minutes, within 5 minutes, within 4 minutes, within 3 minutes within 2 minutes, or within 1 minute. In any embodiment, the term “about” or “approximately” means within 20.0 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “plurality”, and like terms, refers to a number (of things) comprising at least one (thing), or greater than one (thing), as in “two or more” (things), “three or more” (things), “four or more” (things), etc.

As used herein, the terms “connected”, “operationally connected”, “coupled”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In any embodiment, the power supply control system described herein includes a digital processing device, or use of the same. In further embodiments, the digital processing device optionally includes one or more hardware central processing units (CPU) that carry out the device's functions. In still any further embodiments, the digital processing device further comprises an operating system configured to perform executable instructions. In any embodiment, the digital processing device is optionally connected a computer network. In any further embodiments, the digital processing device is optionally connected to the Internet such that it accesses the World Wide Web. In still any further embodiments, the digital processing device is optionally connected to a cloud computing infrastructure. In any embodiments, the digital processing device is optionally connected to an intranet. In any embodiment, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In any embodiment, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In any embodiment, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In any embodiment, the device includes a storage and/or memory device. The storage and/or memory device is one or more physical apparatuses used to store data or programs on a temporary or permanent basis. In any embodiment, the device is volatile memory and requires power to maintain stored information. In any embodiment, the device is non-volatile memory and retains stored information when the digital processing device is not powered. In any further embodiments, the non-volatile memory comprises flash memory. In any embodiment, the non-volatile memory comprises dynamic random-access memory (DRAM). In any embodiment, the non-volatile memory comprises ferroelectric random access memory (FRAM). In any embodiment, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In still further embodiments, the storage and/or memory device may be a combination of devices such as those disclosed herein.

In any embodiment, the digital processing device includes a display to send visual information to a user. In any embodiment, the display is a cathode ray tube (CRT). In any embodiment, the display is a liquid crystal display (LCD). In further embodiments, the display is a thin film transistor liquid crystal display (TFT-LCD). In any embodiment, the display is an organic light emitting diode (OLED) display. In various further embodiments, on OLED display is a passive-matrix OLED (PMOLED) or active-matrix OLED (AMOLED) display. In any embodiment, the display is a plasma display. In other embodiments, the display is a video projector. In still further embodiments, the display is a combination of devices such as those disclosed herein.

In any embodiment, the digital processing device includes an input device to receive information from a user. In any embodiment, the input device is a keyboard. In any embodiment, the input device is a pointing device including, by way of non-limiting examples, a mouse, trackball, track pad, joystick, game controller, or stylus. In any embodiment, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In any embodiment, the power supply control system disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In any embodiment, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In any embodiment, the power supply control system disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In any embodiment, a computer program comprises one sequence of instructions. In any embodiment, a computer program comprises a plurality of sequences of instructions. In any embodiment, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In any embodiment, a computer program includes a web application. In light of the disclosure provided herein, those of skill in the art will recognize that a web application, in various embodiments, utilizes one or more software frameworks and one or more database systems. In any embodiment, a web application is created upon a software framework such as Microsoft® .NET or Ruby on Rails (RoR). In any embodiment, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In any embodiment, a web application is written to some extent in a markup language such as Hypertext Markup Language (HTML), Extensible Hypertext Markup Language (XHTML), or eXtensible Markup Language (XML). In any embodiment, a web application is written to some extent in a presentation definition language such as Cascading Style Sheets (CSS). In any embodiment, a web application is written to some extent in a client-side scripting language such as Asynchronous JavaScript and XML (AJAX), Flash® ActionScript, JavaScript, or Silverlight®. In any embodiment, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In any embodiment, a web application is written to some extent in a database query language such as Structured Query Language (SQL). In any embodiment, a web application integrates enterprise server products such as IBM® Lotus Domino®. In any embodiment, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

### Mobile Application

In any embodiment, a computer program includes a mobile application provided to a mobile digital processing device. In any embodiment, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In any embodiment, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In any embodiment, a computer program includes one or more executable complied applications.

### Web Browser Plug-In

In any embodiment, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In any embodiment, the toolbar comprises one or more web browser extensions, add-ins, or add-ons. In any embodiment, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In any embodiment, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In any embodiment, the power supply control system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In any embodiment, software modules are in one computer program or application. In other embodiments, software modules are in more than one computer program or application. In any embodiment, software modules are hosted on one machine. In other embodiments, software modules are hosted on more than one machine. In further embodiments, software modules are hosted on cloud computing platforms. In any embodiment, software modules are hosted on one or more machines in one location. In other embodiments, software modules are hosted on one or more machines in more than one location.

### Databases

In any embodiment, the power supply control system disclosed herein includes one or more databases, or use of the same. In view of the disclosure provided herein, those of skill in the art will recognize that many databases are suitable for storage and retrieval of drilling fluid recovery data information. In any embodiment, suitable databases include, by way of non-limiting examples, relational databases, non-relational databases, object oriented databases, object databases, entity-relationship model databases, associative databases, and XML databases. In any embodiment, a database is internet-based. In any further embodiments, a database is web-based. In still further embodiments, a database is cloud computing-based. In other embodiments, a database is based on one or more local computer storage devices.

The various functions or processes disclosed herein (such as, for non-limiting example, logic that performs a function or process) may be described as data and/or instructions embodied in various computer-readable media, in terms of their behavioral, register transfer, logic component, transistor, layout geometries, and/or other characteristics. The logic described herein may comprise, according to any embodiments of the invention, software, hardware, or a combination of software and hardware. The logic described herein may comprise computer-readable media, Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the ICS may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above descriptions of illustrated embodiments of the system, methods, or devices are not intended to be exhaustive or to be limited to the precise form disclosed. While specific embodiments of, and examples for, the system, methods, or devices are described herein for illustrative purposes, various equivalent modifications are possible within the scope of the system, methods, or devices, as those skilled in the relevant art will recognize. The teachings of the system, methods, or devices provided herein can be applied to other processing systems, methods, or devices, not only for the systems, methods, or devices described.

The elements and acts of the various embodiments described can be combined to provide further embodiments. These and other changes can be made to the system in light of the above detailed description.

In general, in the following claims, the terms used should not be construed to limit the system, methods, or devices to the specific embodiments disclosed in the specification and the claims, but should be construed to include all processing systems that operate under the claims. Accordingly, the system, methods, and devices are not limited by the disclosure, but instead the scopes of the system, methods, or devices are to be determined entirely by the claims.

While certain aspects of the system, methods, or devices are presented below in certain claim forms, the inventors contemplate the various aspects of the system, methods, or devices in any number of claim forms. For example, while only one aspect of the system, methods, or devices is recited as embodied in machine-readable medium, other aspects may likewise be embodied in machine-readable medium. Accordingly, the inventors reserve the right to add additional claims after filing the application to pursue such additional claim forms for other aspects of the system, methods, or devices.

### Recovery System and Method Description

Accordingly, an apparatus and method for recovering drilling fluid from drill cuttings and drill mud detritus solids from shale slides which may otherwise be lost in a typical drilling operation are described. The apparatus and method can be applied as a drilling fluid recovery system with or without the benefit of common mud shaker systems.

The embodied apparatus mounts to the end of a shale slide. The apparatus has a mesh screen that utilizes an auto adjusting vacuum suction system for filtering drilling fluid from detritus material, and an auto adjustable pump return system with a fluid monitoring system to return recovered waste drilling fluid to the mud tank.

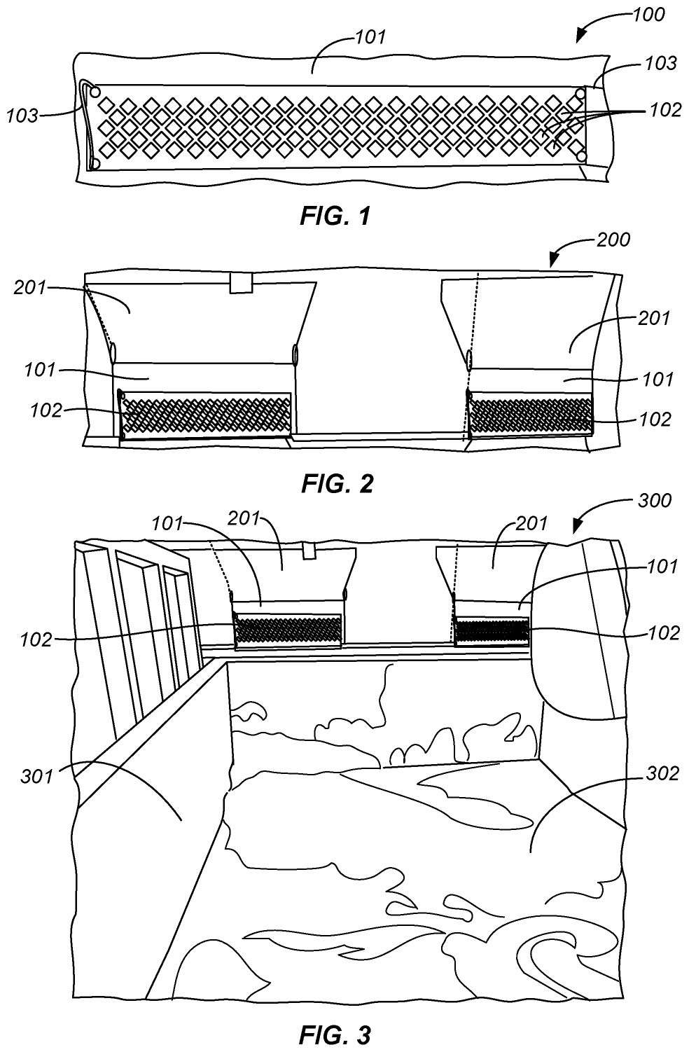

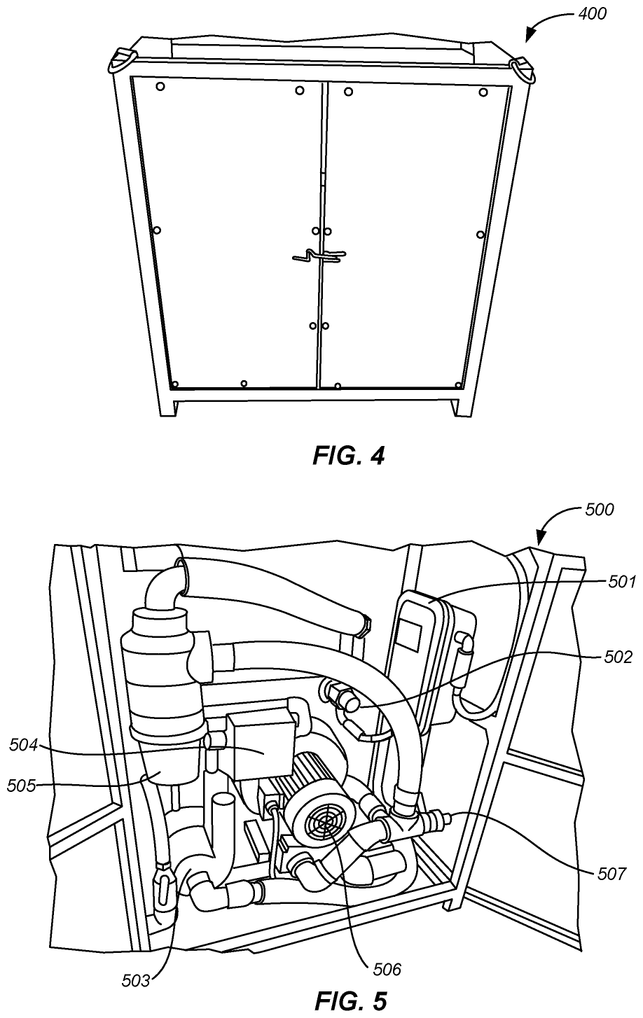

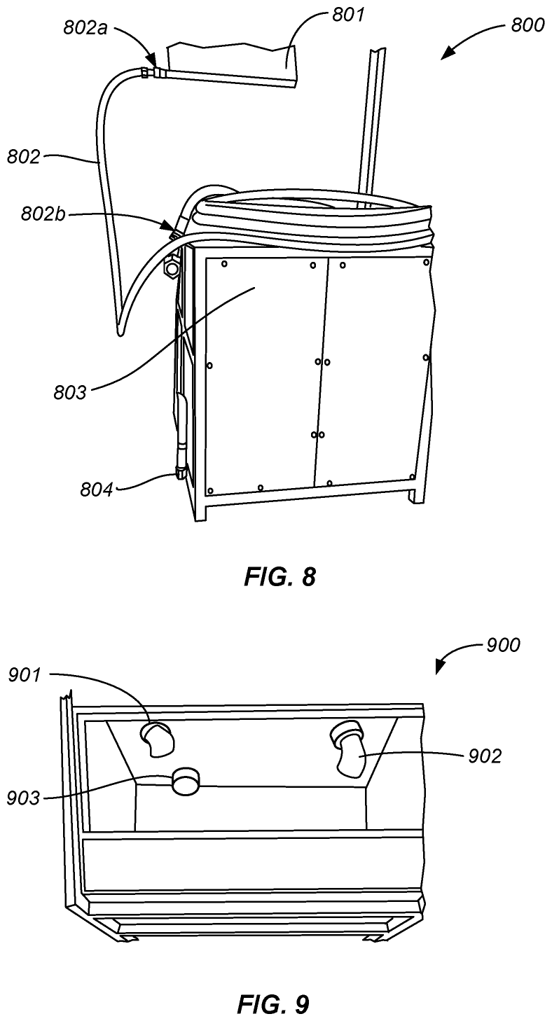

In a first aspect, as illustrated in FIGS. 1-3 and 8, a flow barrier shale catch tray 100, comprising a frame 101, a filter screen 102, and filter screen suction lines 103 attached to the filter screen, can be retrofitted to shale slides 201 to create shale catcher tray assemblies 200. The shale catcher tray assemblies 200, 801 are typically mounted above shale bins 301 that capture and hold the shale (detritus solids) residue 302, and may alternately be referred to as Shale Bin Catch Tray Assemblies 300. The shale catcher tray assemblies 200 are a principal component of the Drilling Fluid Recovery Apparatus 800, comprising the shale catcher tray assemblies 200, 801, a system suction line 802 which transports recovered drilling fluid under suction, from the shale catcher tray assemblies 200, 801 to the storage tank (not shown) in the power cabinet 803 of the Drilling Fluid Recovery Apparatus 800, where the recovered fluid volume is recorded, stored and subsequently discharged via the Discharge (return) Port and delivery line 804 back to the mud tank for reuse.

Provided herein is an apparatus 800 for recovery of drilling fluid from drill cuttings on a shale slide 201, the apparatus comprising; a flow barrier catch tray 100 configured for mounting to the shale slide 201; a fluid filter screen 102 mounted in the flow barrier catch tray 100 configured to be in direct contact with detritus material flow in the shale slide 102, the detritus material flow comprising drilling fluid and drill cuttings; a system suction line 802 having first and second ends 802a and 802b, the first end adapted to provide suction to the fluid filter screen 102 and to draw the drilling fluid from the detritus material flow through the fluid filter screen 102; a vacuum suction system to provide the suction to the filter screen suction lines 103 attached to the filter screen 102, the system comprising an air suction pump 501 for applying system suction to the second end 802b of the suction line 802 and drawing the drilling fluid into a fluid capture recovery storage tank 900, and a fluid return pump 503 actuatable by a fluid level float 903 and a tank level switch 502, for pumping recovered drilling fluid exceeding a fluid level detectable by the fluid float 903 and the tank level switch 502 from the recovery storage tank 900.

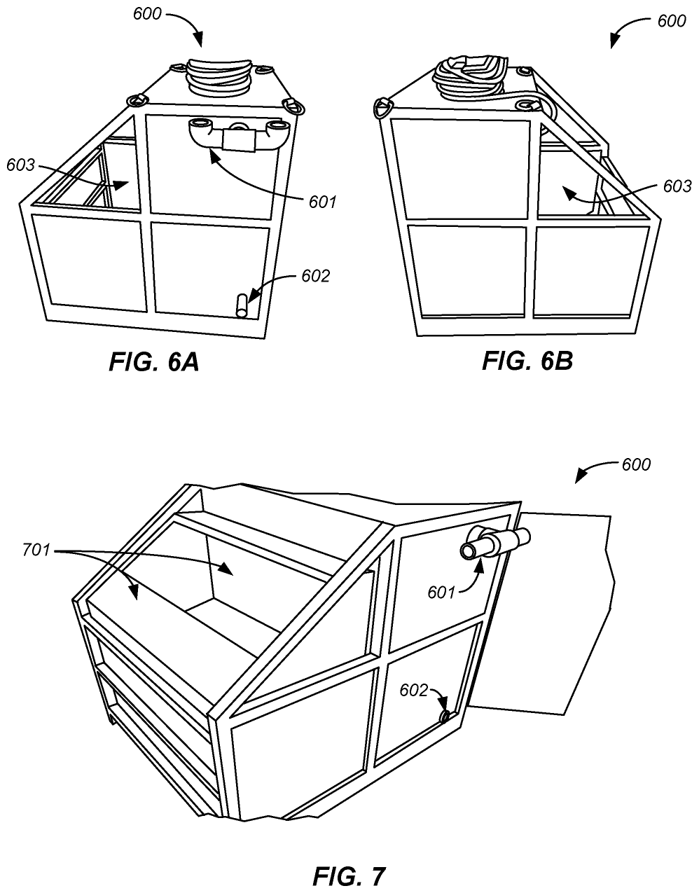

As illustrated in FIG. 5, in any embodiment, the apparatus 800 further comprises a power supply control system 501, alternately referred to as a starter box, for providing power to the apparatus, or automated control of the apparatus, or both.

In any embodiment, the apparatus 800 further comprises a self-contained power cabinet 803, 400 comprising the power supply control system 501, which alternately may be referred to as the starter box, the fluid capture recovery storage tank 900; the vacuum suction system comprising the air suction pump 506, the fluid return pump 503, and the fluid level float 903 and the tank level switch 502.

In any embodiment, the apparatus further comprises a fluid meter 504 for measuring a volume of recovered drilling fluid 1002.

In any embodiment, the apparatus further comprises a discharge return port 804 coupled to a discharge return line 805 for removal of recovered drilling fluid from the storage tank 900 and return to the mud tank.

In any embodiment of the apparatus, the storage tank 900 is adapted for temporarily storing the recovered drilling fluid deposited in the tank through the fluid tank entry line 902, before return to the mud tank for reuse through the suction discharge line 901, as illustrated in FIG. 9.

In any embodiment of the apparatus, the self-contained cabinet 400, 500 further comprises a vacuum relief valve 507 to control air flow in the vacuum suction system as further illustrated in FIG. 5.

In any embodiment of the apparatus, the self-contained cabinet 400, 500, 600, can be fabricated with or without an inclusive fluid capture recovery storage tank. In any embodiment, the fluid capture recovery storage tank can be a separable unit, removable from the self-contained cabinet as illustrated in FIGS. 6-A and 6-B, providing a fluid storage tank area 603, a detachable input (suction) line 601 and a detachable output (discharge) line 602 in the self-contained cabinet 600. In still other embodiments, a separable fluid capture recovery storage tank 701 can be inserted in the self-contained cabinet 600, as illustrated in FIG. 7

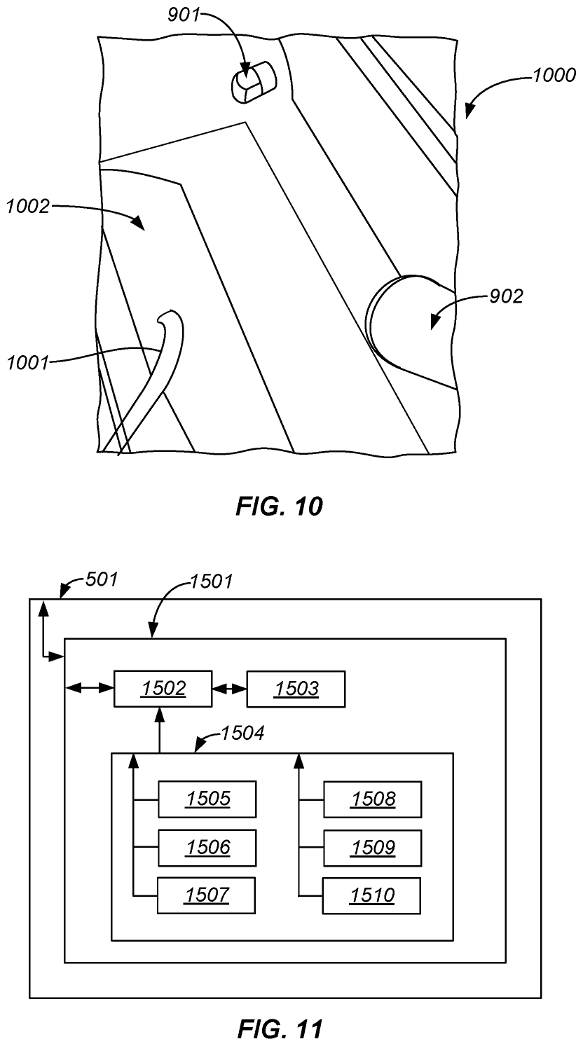

In any embodiment of the apparatus, the fluid capture recovery storage tank 900, 1000 further comprises a floating suction tube 1001 for skimming fluid from the recovered drilling fluid 1002, as illustrated in FIG. 10.

In any embodiment of the apparatus, the fluid capture recovery storage tank 900 further comprises a system for utilizing air returning from the fluid filter screen 102, 103, 802 to generate an air agitation mechanism for agitating the recovered drilling fluid and for preventing low gravity solids suspended in the recovered drilling fluid 1002 from settling to the bottom of the tank.

In any embodiment of the apparatus, the fluid level float 903 is configured to function in concert with the tank level switch 502 to activate a timer (not shown) in a starter box 501 for controlling the fluid return pump 503.

In any embodiment of the apparatus, the fluid return pump 503 is configured for providing positive pressure fluid flow to pump recovered drilling fluid 1002 from the fluid capture recovery storage tank 900.

In any embodiment of the apparatus, the fluid return pump is configured with a secondary shutoff system 505 to protect the pump 503 from fluid bypassing a primary shutoff valve in the fluid capture recovery storage tank.

In any embodiment of the apparatus, the fluid meter 504 is configured such that recovered drilling fluid 1002 from the fluid capture recovery storage tank 900 is pumped therethrough, such that the fluid meter records a flow volume of recovered drilling fluid.

In any embodiment of the apparatus, the discharge return port 904 and the discharge line 905 are configured such that recovered drilling fluid 1002 may be pumped therethrough to a mud tank.

In any embodiment, the apparatus further comprises an agitator (not shown) for agitating the shale slide, thus facilitating detritus material flow.

In any embodiment of the apparatus, the agitator (not shown) comprises a vibratory system (not shown) and an impactor system (not shown).

In any embodiment, the apparatus further comprises an adjustor (not shown) for adjusting the angle of the shale slide 201.

In any embodiment of the apparatus, the adjustor (not shown) comprises one or more of: a manual system; a hydraulic system and an electric system. The manual system can comprise chains and cranks to adjust the angle of the slide 201 using pulleys, gears, or both. Alternatively, a mechanical spring mechanism can be applied to a shale slide tray, wherein the weight of the drill cuttings and drill mud detritus solids, deflects the shale slide tray allowing the pitch of the slide to drop down at a steeper angle. When the weight falls off the shale slide tray, the mechanical spring mechanism pushes the pitch angle of the shale slide tray back up. Whereas, a hydraulic system can comprise a hydraulic pump to drive a piston to adjust the angle of the slide 201. Still further, an electric system can utilize a motor to drive pulleys, gears, chains or pistons to adjust the angle of the slide 201.

In any embodiment of the apparatus, the flow barrier catch tray is configured with a mounting attachment (not shown) that provides for temporary relocation or removal of the flow barrier catch tray away from the direct path of the drill cuttings, drill mud detritus solids or both on the shale slide.

In any embodiment of the apparatus, the mounting attachment for the flow barrier catch tray is configured to allow for the temporary placement or storage of the flow barrier catch tray beneath the shale slide.

One of skill in the art will recognize that secondary operations and maintenance of the system often requires the removal or temporary relocation of components. However, as is frequently the case in field operations, weight or surrounding conditions make it inconvenient to completely remove a component from the rig. Subsequently, it was recognized that the flow barrier catch tray would be more functional with a mounting bracket that allowed it to swing out of the flow path and store beneath, well above or along the side of the shale slide.

In any embodiment of the apparatus, the fluid filter screen 102 is removable.

In any embodiment of the apparatus, the vacuum relief valve 507 is auto-adjusting.

In any embodiment of the apparatus, the power supply control system 501 further comprises a computer implemented system 1501 for automated control of the apparatus 800, as illustrated in FIG. 11, comprising: a digital processing device 1502 comprising an operating system configured to perform executable instructions and a memory 1503; a computer program 1504 including instructions executable by the digital processing device 1502 to create an application comprising: a software module configured to manage a (liquid) fluid flow pumping operation of the apparatus 1505; a software module configured to manage an (air/gas) fluid flow pumping operation of the apparatus 1506; a software module configured to monitor a plurality of sensors 1507; a software module configured to manage a plurality of switches 1508; a software module configured to monitor and track overall run-time of the apparatus 1509; and a software module configured to manage an electrical system of the apparatus 1509.

In any embodiment, the plurality of sensors, (not shown), are configured to monitor apparatus parameters comprising one or more of: liquid fluid flow, air fluid flow, vacuum pressure, fluid levels, and power levels.

Provided herein is a method for recovery of drilling fluid 1002 from drill cuttings comprising: mounting a flow barrier catch tray 100 to a shale slide 201; affixing a fluid filter screen 102 to a frame 101 in the flow barrier catch tray 100 configured to be in direct contact with a detritus material flow in the shale slide 102, the detritus material flow comprising drilling fluid and drill cuttings; attaching a system suction line 802 having first and second ends 802a, 802b, the first end adapted to provide suction to the fluid filter screen suction lines 103 attached to the fluid filter screen 102 and to draw the drilling fluid 1002 from the detritus material flow through the fluid filter screen 102; providing a vacuum suction system to provide the system suction to the fluid filter screen 102, the system comprising an air suction pump 506 for applying suction to the second end 802b of the system suction line 802 and drawing the drilling fluid 1002 into a fluid capture recovery storage tank 900, and providing a fluid return pump 503 actuatable by a fluid level float 903 and a tank level switch 502, for pumping recovered drilling fluid 1002 exceeding a fluid level detectable by the fluid float 903 and the tank level switch 502 from the recovery storage tank 900.

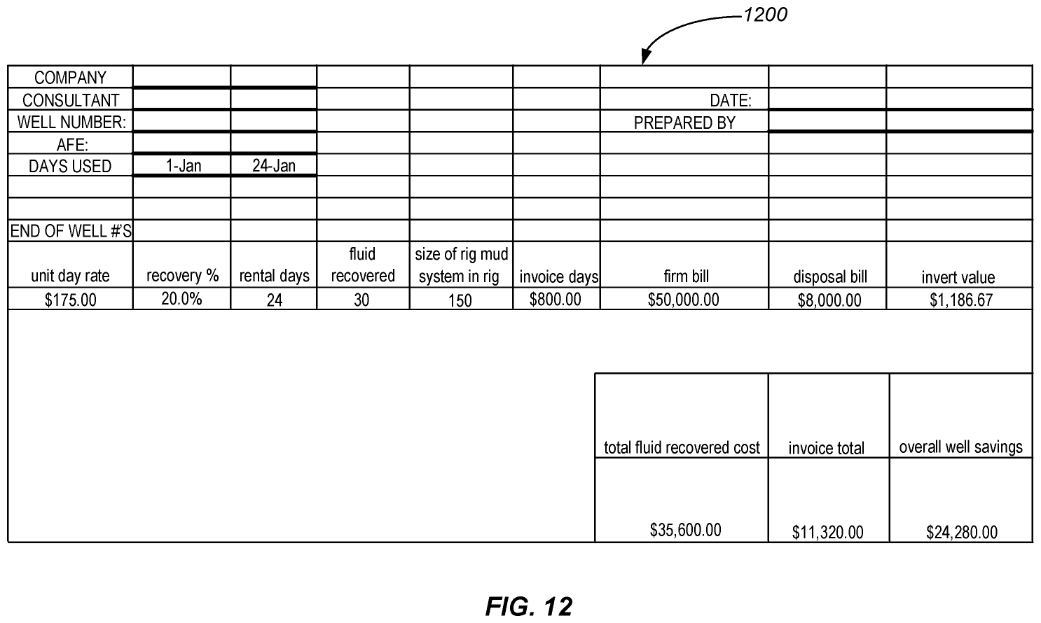

FIG. 12 provides an illustrative representation of the cost benefits realized by use of the apparatus. As shown, well cost savings based on drilling fluid volumes and drill cutting volumes are calculated based on specific recovery rates and the size of the rig mud system.

FIG. 12 shows that over a 24 day drilling program, $24,280.00 in overall well savings would be achieved. When considering the bulk of cuttings processing equipment, requiring mobilization and demobilization costs, as well as costing $1500-$2000 per day for rental fees, conventional cuttings equipment is not cost effective as a means of effectively reducing the overall costs of a drilling program. However, the described herein can be deployed at a significantly lower daily cost and hence allows the operator to achieve a significant net savings on the fluid recovery.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An apparatus for recovery of drilling fluid from drill cuttings, drill mud detritus solids, or both on a shale slide, the apparatus comprising;
a flow barrier catch tray configured for mounting to the shale slide;
a fluid filter screen mounted in the flow barrier catch tray configured to be in direct contact with detritus material flow in the shale slide, the detritus material flow comprising drilling fluid and drill cuttings;
a suction line having first and second ends, the first end adapted to provide suction to the fluid filter screen and to draw the drilling fluid from the detritus material flow through the fluid filter screen;
a vacuum suction system to provide the suction to the fluid filter screen, the system comprising an air suction pump for applying suction to the second end of the suction line and drawing the drilling fluid into a fluid capture recovery storage tank, and
a fluid return pump actuatable by a fluid level float and a tank level switch, for pumping recovered drilling fluid exceeding a fluid level detectable by the fluid float and the tank level switch from the recovery storage tank.

2. The apparatus of claim 1, further comprising a power supply control system for providing power to the apparatus, or automated control of the apparatus, or both.

3. The apparatus of claim 2, further comprising a self-contained cabinet comprising:
the power supply control system,
the fluid capture recovery storage tank;
the vacuum suction system comprising the air suction pump,
the fluid return pump, and
the fluid level float and the tank level switch.

4. The apparatus of claim 1, further comprising a fluid meter for measuring a volume of recovered drilling fluid.

5. The apparatus of claim 1, further comprising a discharge return port coupled to a discharge return line for removal of recovered drilling fluid from the storage tank.

6. The apparatus of claim 4, wherein the storage tank is adapted for temporarily storing the recovered drilling fluid before reuse.

7. The apparatus of claim 1, wherein the self-contained cabinet further comprises a vacuum relief valve to control air flow in the vacuum suction system.

8. The apparatus of claim 1, wherein the fluid capture recovery storage tank further comprises a floating suction tube for skimming fluid from the recovered drilling fluid.

9. The apparatus of claim 1, wherein the fluid capture recovery storage tank further comprises a system for utilizing air returning from the fluid filter screen to generate an air agitation mechanism for agitating the recovered drilling fluid and for preventing low gravity solids suspended in the recovered drilling fluid from settling to the bottom of the tank.

10. The apparatus of claim 1, wherein the fluid level float is configured to function in concert with the tank level switch to activate a timer in a starter box for controlling the fluid return pump.

11. The apparatus of claim 1, wherein the fluid return pump is configured for providing positive pressure fluid flow to pump recovered drilling fluid from the fluid capture recovery storage tank.

12. The apparatus of claim 4, wherein the fluid meter is configured such that recovered drilling fluid from the fluid capture recovery storage tank is pumped therethrough, such that the fluid meter records a flow volume of recovered drilling fluid.

13. The apparatus of claim 5, wherein the discharge return port and the discharge line are configured such that recovered drilling fluid may be pumped therethrough to a mud tank.

14. The apparatus of claim 1, further comprising an agitator for agitating the shale slide, thus facilitating detritus material flow.

15. The apparatus of claim 14, wherein the agitator comprises;
a vibratory system; and
an impactor system.

16. The apparatus of claim 1, further comprising an adjustor for adjusting the angle of the shale slide.

17. The apparatus of claim 16, wherein the adjustor comprises one or more of:
a manual system;
a mechanical spring system;
a hydraulic system; and
an electric system.

18. The apparatus of claim 1, wherein the fluid filter screen is removable from the flow barrier catch tray.

19. The apparatus of claim 7, wherein the vacuum relief valve is auto-adjusting.

20. The apparatus of claim 2, wherein the power supply control system further comprises a computer implemented system for automated control of the apparatus comprising:
a. a digital processing device comprising an operating system configured to perform executable instructions and a memory;
b. a computer program including instructions executable by the digital processing device to create an application comprising:
i. a software module configured to manage a (liquid) fluid pumping operation of the apparatus;
ii. a software module configured to manage an (air/gas) fluid pumping operation of the apparatus;
iii. a software module configured to monitor a plurality of sensors;
iv. a software module configured to manage a plurality of switches;
v. a software module configured to monitor and track monitor and track overall run-time of the apparatus; and
vi. a software module configured to manage an electrical system of the apparatus.

21. The apparatus of claim 20, wherein the plurality of sensors are configured to monitor apparatus parameters comprising one or more of:
(liquid) fluid flow,
(air) fluid flow,
vacuum pressure,
fluid levels, and
power levels.

22. A method for recovery of drilling fluid from drill cuttings comprising:
mounting a flow barrier catch tray to a shale slide;
affixing a fluid filter screen in the flow barrier catch tray configured to be in direct contact with a detritus material flow in the shale slide, the detritus material flow comprising drilling fluid and drill cuttings;
attaching a system suction line having first and second ends, the first end adapted to provide suction to the to a filter suction line attached fluid filter screen and to draw the drilling fluid from the detritus material flow through the fluid filter screen;
providing a vacuum suction system to provide the suction to the fluid filter screen, the system comprising an air suction pump for applying suction to the second end of the system suction line and drawing the drilling fluid into a fluid capture recovery storage tank, and
providing a fluid return pump actuatable by a fluid level float, the fluid level float configured to function in concert with the tank level switch to activate a timer in a starter box for controlling the fluid return pump and a tank level switch, for pumping recovered drilling fluid exceeding a fluid level detectable by the fluid float and the tank level switch from the recovery storage tank.

23. An apparatus for recovery of drilling fluid from drill cuttings on a shale slide, the apparatus comprising;
a flow barrier catch tray configured for mounting to the shale slide;
a removable fluid filter screen mounted in the flow barrier catch tray configured to be in direct contact with detritus material flow in the shale slide, the detritus material flow comprising drilling fluid and drill cuttings;
a suction line having first and second ends, the first end adapted to provide suction to the fluid filter screen and to draw the drilling fluid from the detritus material flow through the fluid filter screen;
a vacuum suction system to provide the suction to the fluid filter screen, the system comprising an air suction pump for applying suction to the second end of the suction line and drawing the drilling fluid into a fluid capture recovery storage tank, the storage tank being adapted for temporarily storing the recovered drilling fluid before reuse, the tank comprising a floating suction tube for skimming fluid from the recovered drilling fluid and a system for utilizing air returning from the fluid filter screen to generate an air agitation mechanism for agitating the recovered drilling fluid and for preventing low gravity solids suspended in the recovered drilling fluid from settling to the bottom of the tank;
a fluid return pump actuatable by a fluid level float and a tank level switch, for pumping recovered drilling fluid exceeding a fluid level detectable by the fluid float and the tank level switch from the recovery storage tank, the pump configured for providing positive pressure fluid flow to pump recovered drilling fluid from the fluid capture recovery storage tank;
a power supply control system for providing power to the apparatus, or automated control of the apparatus, or both;
a self-contained cabinet comprising:
the power supply control system;
the fluid capture recovery storage tank;
the vacuum suction system comprising the air suction pump,
the fluid return pump;
the fluid level float and the tank level switch; and
an auto-adjusting vacuum relief valve to control air flow in the vacuum suction system;
a fluid meter for measuring a volume of recovered drilling fluid, the fluid meter configured such that recovered drilling fluid from the fluid capture recovery storage tank is pumped therethrough, such that the fluid meter records a flow volume of recovered drilling fluid;
a discharge return port coupled to a discharge return line for removal of recovered drilling fluid from the storage tank, the discharge return port and the discharge line configured such that recovered drilling fluid may be pumped therethrough to a mud tank; and
an agitator for agitating the shale slide, thus facilitating detritus material flow, the agitator comprising a vibratory system and an impactor system;
an adjustor for adjusting the angle of the shale slide, the adjustor comprising one or more of: a manual system; a hydraulic system; and an electric system.

24. The apparatus of claim 1, wherein the flow barrier catch tray is configured with a mounting attachment that provides for temporary relocation or removal of the flow barrier catch tray away from the direct path of the drill cuttings, drill mud detritus solids, or both on the shale slide.

25. The apparatus of claim 24, wherein the mounting attachment for the flow barrier catch tray is configured to allow for the temporary placement or storage of the flow barrier catch tray beneath the shale slide.

26. An apparatus for recovery of drilling fluid from drill cuttings, drill mud detritus solids, or both on a shale slide, the apparatus comprising;
a catch tray configured for mounting to the shale slide;
a fluid filter screen mounted in the catch tray configured to be in direct contact with detritus material flow in the shale slide, the detritus material flow comprising drilling fluid and drill cuttings;
a suction line having first and second ends, the first end adapted to provide suction to the fluid filter screen and to draw the drilling fluid from the detritus material flow through the fluid filter screen;
a vacuum suction system to provide the suction to the fluid filter screen, the system comprising an air suction pump for applying suction to the second end of the suction line and drawing the drilling fluid into a fluid capture recovery storage tank, and
a fluid return pump actuatable by a fluid level float and a tank level switch, for pumping recovered drilling fluid exceeding a fluid level detectable by the fluid float and the tank level switch from the recovery storage tank.

27. The apparatus of claim 26, further comprising a power supply control system for providing power to the apparatus, or automated control of the apparatus, or both.

28. The apparatus of claim 27, further comprising a self-contained cabinet comprising:
the power supply control system,
the fluid capture recovery storage tank;
the vacuum suction system comprising the air suction pump,
the fluid return pump, and
the fluid level float and the tank level switch.

29. The apparatus of claim 26, further comprising a fluid meter for measuring a volume of recovered drilling fluid.

30. The apparatus of claim 26, further comprising a discharge return port coupled to a discharge return line for removal of recovered drilling fluid from the storage tank.

31. The apparatus of claim 29, wherein the storage tank is adapted for temporarily storing the recovered drilling fluid before reuse.

32. The apparatus of claim 26, wherein the self-contained cabinet further comprises a vacuum relief valve to control air flow in the vacuum suction system.

33. The apparatus of claim 26, wherein the fluid capture recovery storage tank further comprises a floating suction tube for skimming fluid from the recovered drilling fluid.

34. The apparatus of claim 26, wherein the fluid capture recovery storage tank further comprises a system for utilizing air returning from the fluid filter screen to generate an air agitation mechanism for agitating the recovered drilling fluid and for preventing low gravity solids suspended in the recovered drilling fluid from settling to the bottom of the tank.

35. The apparatus of claim 26, wherein the fluid level float is configured to function in concert with the tank level switch to activate a timer in a starter box for controlling the fluid return pump.

36. The apparatus of claim 26, wherein the fluid return pump is configured for providing positive pressure fluid flow to pump recovered drilling fluid from the fluid capture recovery storage tank.

37. The apparatus of claim 29, wherein the fluid meter is configured such that recovered drilling fluid from the fluid capture recovery storage tank is pumped therethrough, such that the fluid meter records a flow volume of recovered drilling fluid.

38. The apparatus of claim 30, wherein the discharge return port and the discharge line are configured such that recovered drilling fluid may be pumped therethrough to a mud tank.

39. The apparatus of claim 26, further comprising an agitator for agitating the shale slide, thus facilitating detritus material flow.

40. The apparatus of claim 39, wherein the agitator comprises;
a vibratory system; and
an impactor system.

41. The apparatus of claim 26, further comprising an adjustor for adjusting the angle of the shale slide.

42. The apparatus of claim 41, wherein the adjustor comprises one or more of:
a manual system;
a mechanical spring system;
a hydraulic system; and
an electric system.

43. The apparatus of claim 26, wherein the catch tray further comprises a flow barrier to create a flow barrier catch tray.

44. The apparatus of claim 26, wherein the fluid filter screen is removable from the catch tray.

45. The apparatus of claim 32, wherein the vacuum relief valve is auto-adjusting.

46. The apparatus of claim 27, wherein the power supply control system further comprises a computer implemented system for automated control of the apparatus comprising:
c. a digital processing device comprising an operating system configured to perform executable instructions and a memory;
d. a computer program including instructions executable by the digital processing device to create an application comprising:
i. a software module configured to manage a (liquid) fluid pumping operation of the apparatus;
ii. a software module configured to manage an (air/gas) fluid pumping operation of the apparatus;
iii. a software module configured to monitor a plurality of sensors;
iv. a software module configured to manage a plurality of switches;
v. a software module configured to monitor and track monitor and track overall run-time of the apparatus; and
vi. a software module configured to manage an electrical system of the apparatus.

47. The apparatus of claim 46, wherein the plurality of sensors are configured to monitor apparatus parameters comprising one or more of:
liquid fluid flow,
air fluid flow,
vacuum pressure,
fluid levels, and
power levels.

48. A method for recovery of drilling fluid from drill cuttings comprising:
mounting a catch tray to a shale slide;
affixing a fluid filter screen in the catch tray configured to be in direct contact with a detritus material flow in the shale slide, the detritus material flow comprising drilling fluid and drill cuttings;
attaching a system suction line having first and second ends, the first end adapted to provide suction to the to a filter suction line attached fluid filter screen and to draw the drilling fluid from the detritus material flow through the fluid filter screen;
providing a vacuum suction system to provide the suction to the fluid filter screen, the system comprising an air suction pump for applying suction to the second end of the system suction line and drawing the drilling fluid into a fluid capture recovery storage tank, and
providing a fluid return pump actuatable by a fluid level float, the fluid level float configured to function in concert with the tank level switch to activate a timer in a starter box for controlling the fluid return pump and a tank level switch, for pumping recovered drilling fluid exceeding a fluid level detectable by the fluid float and the tank level switch from the recovery storage tank.

49. An apparatus for recovery of drilling fluid from drill cuttings on a shale slide, the apparatus comprising;
a catch tray configured for mounting to the shale slide;
a removable fluid filter screen mounted in the catch tray configured to be in direct contact with detritus material flow in the shale slide, the detritus material flow comprising drilling fluid and drill cuttings;
a suction line having first and second ends, the first end adapted to provide suction to the fluid filter screen and to draw the drilling fluid from the detritus material flow through the fluid filter screen;
a vacuum suction system to provide the suction to the fluid filter screen, the system comprising an air suction pump for applying suction to the second end of the suction line and drawing the drilling fluid into a fluid capture recovery storage tank, the storage tank being adapted for temporarily storing the recovered drilling fluid before reuse, the tank comprising a floating suction tube for skimming fluid from the recovered drilling fluid and a system for utilizing air returning from the fluid filter screen to generate an air agitation mechanism for agitating the recovered drilling fluid and for preventing low gravity solids suspended in the recovered drilling fluid from settling to the bottom of the tank;
a fluid return pump actuatable by a fluid level float and a tank level switch, for pumping recovered drilling fluid exceeding a fluid level detectable by the fluid float and the tank level switch from the recovery storage tank, the pump configured for providing positive pressure fluid flow to pump recovered drilling fluid from the fluid capture recovery storage tank;
a power supply control system for providing power to the apparatus, or automated control of the apparatus, or both;
a self-contained cabinet comprising:
the power supply control system;
the fluid capture recovery storage tank;
the vacuum suction system comprising the air suction pump,
the fluid return pump;
the fluid level float and the tank level switch; and
an auto-adjusting vacuum relief valve to control air flow in the vacuum suction system;
a fluid meter for measuring a volume of recovered drilling fluid, the fluid meter configured such that recovered drilling fluid from the fluid capture recovery storage tank is pumped therethrough, such that the fluid meter records a flow volume of recovered drilling fluid;
a discharge return port coupled to a discharge return line for removal of recovered drilling fluid from the storage tank, the discharge return port and the discharge line configured such that recovered drilling fluid may be pumped therethrough to a mud tank; and
an agitator for agitating the shale slide, thus facilitating detritus material flow, the agitator comprising a vibratory system and an impactor system;
an adjustor for adjusting the angle of the shale slide, the adjustor comprising one or more of: a manual system; a hydraulic system; and an electric system.

50. The apparatus of claim 43, wherein the catch tray is configured with a mounting attachment that provides for temporary relocation or removal of the flow barrier catch tray away from the direct path of the drill cuttings, -drill mud detritus solids, or both on the shale slide.

51. The apparatus of claim 50, wherein the mounting attachment for the flow barrier catch tray is configured to allow for the temporary placement or storage of the flow barrier catch tray beneath the shale slide.
